(19) United States
(12) Patent Application Publication
(10) Pub. No.: US 2011/0264414 A1
(43) Pub. Date: Oct. 27, 2011

(54) METHOD FOR DETERMINING ABSOLUTE LAYOUT PARAMETERS OF OBJECTS, ASSOCIATED COMPUTER PROGRAMME AND CONTROL INSTALLATION

(75) Inventors: Mikael CARMONA, Grenoble (FR); Olivier Michel, Grenoble (FR)

(73) Assignees: Institut Polytechnique De Grenoble, Grenoble Cedex 1 (FR); Comm. a I' ener. atom. et aux energies alter., Paris (FR)

(21) Appl. No.: 13/073,236

(22) Filed: Mar. 28, 2011

(30) Foreign Application Priority Data
Mar. 29, 2010 (FR) 10 52301

(51) Int. Cl. G06F 17/50

(52) U.S. Cl. 703/1

(57) ABSTRACT

This method comprises the following steps: the obtaining (210; 210*) of relative layout parameters, each between two objects of a set of objects; the association (211; 211*), with each relative layout parameter received, of a value, called reliability of the relative layout parameter. It moreover comprises the following loop of steps (212; 212*), executed at least once: the selection (214; 214*) of a working sub-set, as a function of the reliabilities of the relative layout parameters; the determination (230; 230*) of new relative layout parameters, each between an object belonging to the working sub-set and an object external to the working sub-set; the association (232; 232*), with each new determined relative layout parameter, of a reliability calculated from the reliabilities of the relative layout parameters of the objects of the working sub-set. It moreover comprises the supply (231) of absolute layout parameters, each of an object of the set, said parameters being obtained from the new determined relative layout parameters.

The present invention relates to a method for determining absolute layout parameters of objects, an associated computer programme and a control installation.

### BACKGROUND OF THE INVENTION

In the description and the claims that follow, the following terminology will be used.

The “relative layout” of two objects is the geometric configuration of the two objects in relation to each other.

A “relative layout parameter” is information that makes it possible to characterise at least in part the relative layout of the two objects. It may in particular be the distance (Euclidian) between the two objects or the relative orientation of the two objects.

The “absolute layout” of an object is the geometrical configuration of the object compared to a reference (or frame of reference).

An “absolute layout parameter” is information making it possible to characterise, at least in part, the absolute layout of the object. It may be in particular the position of the object in relation to the reference or the orientation of the object in relation to the reference.

### DESCRIPTION OF THE PRIOR ART

A method for determining an absolute layout parameter of objects was proposed at the conference given on the 12 to 14 Aug. 2009 at Northern Illinois University, in the presentation entitled “Explicit Sensor Network Localization using Semidefinite Programming and Clique Reductions”, by Nathan Krislock and Henry Wolkowicz.

More specifically, the objects are sensors and the absolute layout parameter is the position of said sensors. These positions are determined from the knowledge of the absolute position of certain of said sensors, known as reference sensors, and relative layout parameters between sensors, namely the distance separating them two by two, said distances being grouped together in a matrix of distances.

This method proposes completing the matrix of distances by taking advantage of the overlap of complete blocks (in other words for which all of the distances between sensors are known) of this matrix of distances, which amounts to considering the overlap of complete sub-sets of the network of sensors. Once the matrix of distances is completed, the position of each sensor is determined. This method enables an explicit resolution of the problem.

However, this method only applies in the case where the distance between each pair of sensors separated by a distance less than a predetermined parameter R (called radio parameter) is known. Moreover, it is only applicable to not noisy data (positions of the reference sensors and start distances known in an exact manner).

It may thus be desirable to provide a method for determining an absolute layout parameter of objects that makes it possible to overcome at least part of the aforementioned problems and constraints.

### SUMMARY OF THE INVENTION

An object of the invention is thus a method for determining an absolute layout parameter of objects, comprising the following steps:
the obtaining of relative layout parameters, each between two objects of a set of objects,
the association, with each relative layout parameter received, of a value, called reliability of the relative layout parameter,
   the following loop of steps, executed at least once:
the selection of a sub-set of objects, called working sub-set, as a function of the reliabilities of the relative layout parameters of the objects of the set,
the determination of new relative layout parameters, each between an object belonging to the working sub-set and an object external to the working sub-set,
the association, with each new determined relative layout parameter, of a reliability calculated from the reliabilities of the relative layout parameters of the objects of the working sub-set,
   and the following step:
the supply of absolute layout parameters, each of an object of the set, said parameters being obtained from the new determined relative layout parameters.

Thus, thanks to the introduction of the notion of reliability, the invention makes it possible, on the one hand, to favour certain relative layout parameters in relation to others by using the reliabilities in the selection of the working sub-set, and, on the other hand, to take into account the propagation of errors from one iteration to the next by determining the reliabilities of the new parameters determined as a function of the reliabilities of the parameters determined previously.

In particular, the invention makes it possible to favour the data considered the most reliable to find new relative layout parameters and to reduce the influence of the parameters determined after numerous iterations by shrewdly choosing the manner of calculating the reliability of the new parameters.

In an optional manner, the selection of the working sub-set comprises:
the determination of several sub-sets, called possible working sub-sets, and the calculation, for each possible working sub-set, of a value, called reliability of said possible working sub-set, from the reliabilities of the relative layout parameters of the objects of said possible working sub-set, and
the selection, as working sub-set, of the possible working sub-set having the greatest reliability.

Also in an optional manner, the loop of steps moreover comprises the determination of the absolute layout parameter of each object of the working sub-set.

Also in an optional manner, the selection of the working sub-set is moreover carried out by imposing that all of the relative layout parameters of the objects of the working sub-set are known.

Also in an optional manner, the objects for which the absolute layout parameter is known being called reference objects, the determination of the absolute layout parameter of each object of the working sub-set is carried out from the absolute layout parameters of the reference objects of the working sub-set and from the relative layout parameters of the objects of the working sub-set.

Also in an optional manner, the objects for which the absolute layout parameter is known being called reference objects, the objects of the working sub-set and the objects external to the working sub-set between which new relative layout parameters are determined, are reference objects.

Also in an optional manner, the reliability associated with a new relative layout parameter between an object of the working sub-set and an object external to the working sub-set is determined according to a predetermined rule imposing that it is strictly less than the average of the reliabilities of the relative layout parameters of the objects of the working sub-set.

Also in an optional manner, the relative layout parameter between two objects is the distance between said two objects, and the absolute layout parameter of an object is the position of said object compared to a reference.

Also in an optional manner, the relative layout parameter between two objects is the relative orientation between said two objects, and the absolute layout parameter of an object is the absolute orientation of said object compared to a reference.

Also in an optional manner, the loop of steps moreover comprises:
the determination of an eigenvector of a matrix grouping together the relative orientations of the objects of the working sub-set, all of the components of the eigenvector being unitary,
the determination of the absolute orientation of each object of the working sub-set, from the eigenvector and the absolute orientation of a reference object of the working sub-set.

Another object of the invention is a computer programme downloadable from a communications network and/or recorded on a support readable by computer and/or executable by a processor, comprising instructions for the execution of the steps of a method for determining absolute layout parameters of objects according to the invention, when said programme is executed on a computer.

Another object of the invention is a control installation, comprising:
a set of sensors, each sensor being designed to determine a relative layout parameter in relation to at least one other sensor of the set, and to transmit said parameter,
a processing device designed to receive the parameters transmitted by the sensors and to implement a method for determining absolute layout parameters of the sensors according to the invention.

### BRIEF DESCRIPTION OF THE DRAWINGS

The invention will be better understood by means of the description that follows, given uniquely by way of example and made with reference to the appended drawings, in which:

FIG. 1 is a diagram representing a civil engineering work comprising a control installation according to an embodiment of the invention, and

FIG. 2 illustrates the successive steps of a method for controlling a civil engineering structure of the civil engineering work of FIG. 1.

### DESCRIPTION OF THE PREFERRED EMBODIMENTS

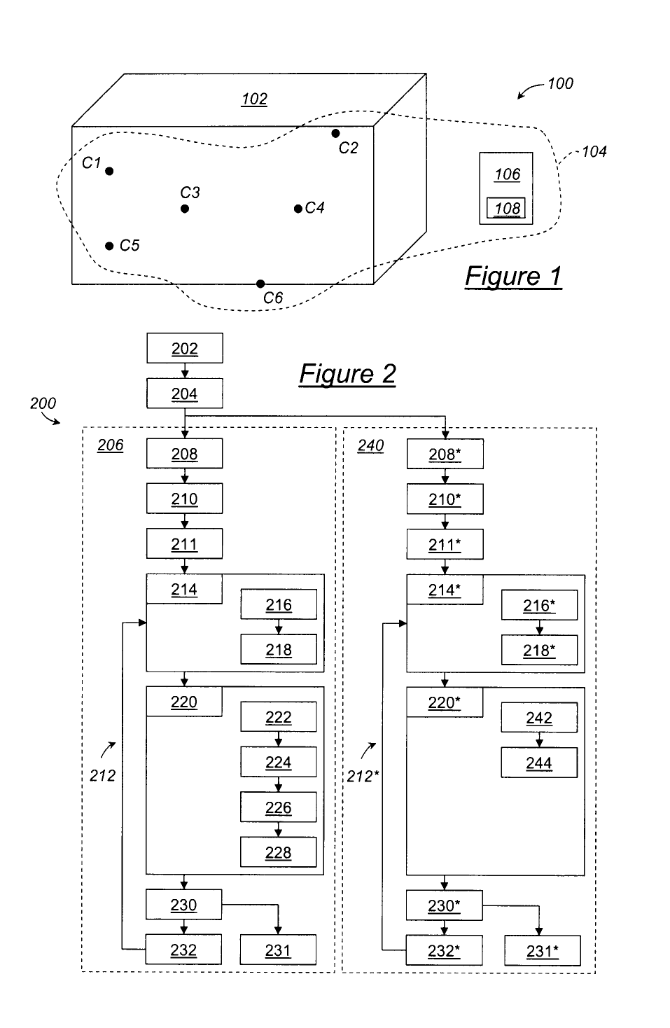

The civil engineering work 100 represented in FIG. 1 comprises a civil engineering structure 102 and an installation 104 for controlling the civil engineering structure 102, intended to monitor the state of the civil engineering structure 102 and in particular its geometric deformations.

To this end, the installation 104 firstly comprises a set of sensors—six in the example illustrated, referenced C1, C2, C3, C4, C5, C6—fixed to the civil engineering structure 102, for example by being buried in said structure. Each sensor is designed to determine relative layout characteristics in relation to the other sensors of the set, and in particular its distance and its orientation using conventional means. Each sensor is moreover designed to transmit, with or without wire, the determined relative layout characteristics to a processing device 106 of the installation 104.

This processing device 106 is connected to each of the sensors by a wired or instead wireless connection, depending on the mode of transmission of the sensors. The processing device 106 is designed to determine the position and the absolute orientation of at least a part of the sensors, if possible all. In the example described, the device 106 is a computer in which is installed a computer programme 108 comprising instructions for the execution of the steps of a method for determining the absolute position of the sensors and a method for determining the absolute orientation of the sensors.

With reference to FIG. 2, a method 200 for controlling the civil engineering structure 102, implemented by the installation 104, comprises the following steps.

During a step 202, each of the sensors C1, C2, C3, C4, C5, C6 aims to determine its distance in relation to the other sensors. Generally, the distance may be determined as long as the two sensors are not too far from each other and no opaque obstacle (in the sense of the visibility of the sensors) is placed between them. Each sensor thus determines no distance, a single distance or instead several distances with other sensors.

During a step 204, the sensors C1, C2, C3, C4, C5, C6 transmit the distances determined to the processing device 106.

Then, the processing device 106, executing the computer programme 108, implements a method 206 for determining positions of at least a part of the sensors C1, C2, C3, C4, C5, C6 that comprises the steps detailed below.

During a step 208, the processing device 106 receives positions (absolute), each of a sensor of the set. The sensors for which the position is known are hereafter called reference sensors.

During a step 210, the processing device 106 obtains distances between sensors coming from the reception of the distances transmitted by the sensors C1, C2, C3, C4, C5, C6, as well as the calculation of the distances between the reference sensors. Each distance received is thus taken between two respective sensors of the set.

The distances are recorded in a matrix of distances D, with the distance between the sensor Ci and the sensor Cj recorded in the location (i, j) of the matrix of distances D. The matrix of distances D is thus a symmetrical matrix. Moreover, generally, certain distances between sensors are not known, so that certain locations of the matrix of distances D are empty. The matrix of distances D is thus mathematically known as “incomplete”. Finally, the distances received by the processing device 106 and recorded in the matrix of distances D generally have an error in relation to the real distances between the sensors, so that the matrix of distances D is known as “noisy”.

During a step 211, the processing device 106 associates, with each distance received, a value called distance reliability. The reliability is for example expressed in the form of a number, in particular between “0” and “1” or in percentage.

The reliability of a distance measured by the sensors is preferably determined from the intrinsic error margin of each sensor. The reliability of a distance calculated from the positions of reference sensors is preferably determined from the intrinsic error margin of the device for measuring the position of said sensors. In both cases, the margin of error is obtained for example by modelling and calculation and/or in an empirical manner by means of tests, from the sensors or the position measurement device. In general, the reliability associated with the distances between reference sensors is greater than the reliability of distances measured by the sensors themselves, for example 95% or more for the first, compared to less than 95% for the second.

The distance reliabilities are recorded in a matrix F, with the distance reliability between the sensor Ci and the sensor Cj recorded in the location (i, j) of the matrix F. This matrix F is thus also symmetrical and incomplete.

The processing device 106 then executes at least once the following loop of steps 212.

During a step 214, the processing device 106 selects a sub-set of sensors, known as working sub-set, as a function of the distance reliabilities between the sensors of the set. In the example described, the working sub-set is determined in such a way that all of the distances between the sensors that it groups together are known. Moreover, the working sub-set is determined in such a way that it comprises at least four non coplanar reference sensors when the determination is carried out in three dimensions, or instead at least three non aligned reference sensors when the determination is carried out in two dimensions.

The distances between the sensors of the working sub-set are recorded in a matrix of distances \hat{D}, in the same way as for the matrix of distances D. Since all of the distances between the sensors of the working sub-set are known, the matrix of distances \hat{D} is mathematically known as “complete”. For the sake of simplification, the notation \hat{D} will be used both for the working sub-set and for the associated matrix of distances.

In the example described, to determine the working sub-set, during a step 216, the processing device 106 determines several possible working sub-sets—complete and comprising depending on the case at least three or four reference sensors—and calculates, for each of them, a value called reliability of the sub-set, from the reliabilities of the distances between the objects of the sub-set. In the example described, the reliability of the sub-set is equal to the average of the reliabilities of the distances between the sensors of the sub-set. Preferably, the average used is the arithmetic average.

According to a possible embodiment, during step 216, the processing device 106 determines a possible working sub-set for each of a part of the sensors of the set, for example for each sensor of the set. For a given sensor Ci, said possible working sub-set may be determined in the following manner. The processing device 106 firstly creates a temporary sub-set comprising uniquely the sensor Ci. The processing device 106 then determines one or more sensors external to the temporary sub-set for which the distance with each of the sensors of the temporary sub-set is known, to at least four reference sensors either that belong to the temporary sub-set (three reference sensors for a localisation in the plane) or for which the distance with each of the sensors of the temporary sub-set is known. Among these determined external sensors, the processing device 106 selects that enabling the sub-set constituted of the temporary sub-set increased with this sensor, to have the greatest reliability. The sensor thereby selected is then added to the temporary sub-set. The three final steps (determination of external sensors, selection of one of said sensors and addition of the selected sensor to the temporary sub-set) are repeated as long as it is possible to find a sensor to add to the temporary sub-set. When this is no longer possible, the temporary sub-set becomes the possible working sub-set for the sensor Ci.

Another manner of proceeding, which may be envisaged in practice only for sets comprising a limited number of sensors, could be to determine all of the theoretically possible working sub-sets, by one of the methods known in itself.

Then, during a step 218, the processing device 106 selects, as working sub-set, the possible working sub-set having the greatest reliability. If several possible working sub-sets have the same reliability, the processing device 106 selects for example that comprising the most reference sensors. If several possible working sub-sets comprise the same number of reference sensors, the processing device 106 selects that comprising two sensors separated by a distance having the greatest reliability. In the event of equality, the processing device 106 then selects arbitrarily one of the possible working sub-sets.

Strictly speaking, the search for the sub-set having the greatest reliability is a problem that comes under graph theory and which is classed NP-difficult. Thus, it is not possible to find in a reasonable time all of the possible working sub-sets, or to check that a possible working sub-set has a maximum reliability, except in the case evoked previously of a limited number of sensors, so that all of the theoretically possible working sub-sets are not necessarily determined at step 216. In practice, this step may thus be implemented in a less than optimal manner without it harming the method as a whole.

During a step 220, the processing device 106 determines the absolute position of each sensor of the working sub-set from the positions of the reference sensors of the working sub-set and the distances between the sensors of the working sub-set. Thus, all of the sensors of the working sub-set become reference sensors.

In the example described, the determination of the position of each sensor of the working sub-set comprises the following steps 222 to 228.

During a step 222, the processing device 106 calculates a matrix G, in the following manner:

$$G = - \frac{1}{2} {H}_{N} \hat{D} {H}_{N} ,$$

with

$${H}_{N} = {I}_{N} - \frac{{J}_{N}}{N} ,$$

where N is the number of sensors in the working sub-set \hat{D}, I_{N} is the identity matrix of order N and J_{N} is the square matrix of order N only containing “1”.

During a step 224, the processing device 106 determines, in the case of a determination of positions of sensors in space, on the one hand, the three largest eigenvalues in absolute value of the matrix G and records them in a diagonal matrix Λ and, on the other hand, the three associated eigenvectors and records them in a matrix P. In the case of a determination of positions of sensors in the plane, only the two largest eigenvalues and associated vectors are determined. This determination is for example carried out by means of singular value decomposition algorithms.

During a step 226, the processing device 106 calculates a matrix Y, in the following manner:

Y=PΛ^{1/2}.

It may be shown that, geometrically, the matrix Y contains the position of each of the sensors of the working sub-set, but in a frame that is not the frame of reference.

During a step 228, the processing device 106 determines the position of each of the sensors of the working sub-set from the matrix Y and the positions of the reference sensors.

During a step 230, the processing device 106 determines new distances, each between a reference sensor belonging to the working sub-set and a reference sensor external to the working sub-set, and completes the matrix D with the new distances found. This determination is easily carried out thanks to the knowledge of the position of each reference sensor.

Then, during a step 232, the processing device 106 associates, with each new distance determined at step 230, a reliability calculated from the reliabilities of the distances between the sensors of the working sub-set. In the example described, the reliability of each new distance is equal to half of the reliability of the working sub-set, in other words half of the average of the distance reliabilities of the sensors of the working sub-set. It will be noted that the reliability associated with a new distance is strictly less than the average of the distance reliabilities of the sensors of the working sub-set. This makes it possible to ensure that the reliability of the new distances determined decreases with the number of executions of the loop of steps 212. Thus, at each execution of the loop of steps 212, it becomes more difficult to find a working sub-set, the reliability of which is greatest and which has not already been found during a previous execution of the loop of steps 212. Thus, the distances determined during first iterations of the loop 212 have a more important weighting than those determined in subsequent iterations. This favours the selection, as working sub-set, of a sub-set comprising sensors separated by distances determined in the first iterations, in relation to the sub-sets comprising sensors separated by distances determined in subsequent iterations. This manner of proceeding reduces the error propagation in the succession of executions of the loop of steps 212.

The processing device 106 then begins a new execution of the loop of steps 212.

However, it will be noted that if no new distance can be determined at this step 230, the processing device 106 can halt the execution of the loop of steps 212 and supply, during a step 231, the positions of the reference sensors of the set of sensors and in particular the distances determined at step 220.

The processing device 106, executing the computer programme 108, also implements a method 240 for determining absolute orientations of the sensors C1, C2, C3, C4, C5, C6. This method 240 is similar to the method 206, apart from the fact that it applies to relative and absolute orientations, rather than to distances and positions. To reflect this change, the steps for which the sequencing remains identical to that of method 206 will be numbered in the same manner, but with an asterisk indicating that the processed data are not the same.

Thus, the position of a sensor is replaced by the absolute orientation of the sensor. In the example described, this absolute orientation is represented by a quaternion.

The distance between two sensors is replaced by the relative orientation between two sensors. In the example described, said relative orientation is also represented by a quaternion.

The matrix of distances D of the set of sensors is replaced by a matrix of relative orientations O, in which the relative orientation between the sensor Ci and the sensor Cj is recorded in the location (i, j) of the matrix of relative orientations O. In the example described, the matrix O is thus a matrix of symmetric quaternions.

Likewise, the matrix of distances \hat{D} of the working sub-set is replaced by a matrix of relative orientations Ô of the working sub-set and distance reliabilities are replaced by relative orientation reliabilities.

Moreover, the working sub-set comprises at least one reference sensor (in other words, within the scope of method 240, a sensor for which the absolute orientation is known), instead of at least three or four reference sensors for the method 206.

Moreover, the determination 220* of the absolute orientation of each sensor of the working sub-set comprises the following steps 242 and 244, instead of steps 222 to 228.

During a step 242, the processing device 106 determines, on the one hand, the largest eigenvalue in absolute value of the matrix of relative orientations Ô of the working sub-set and, on the other hand, the associated eigenvector, noted V, composed uniquely of unitary quaternions.

During a step 244, the processing device 106 determines the absolute orientation of each of the sensors of the working sub-set from the eigenvector V and the absolute orientation of the reference sensor of the working sub-set.

In the example described, this determination is carried out by the following calculation:

\hat{Q}=V×( v̅ᵢqᵢ),

where

$$\hat{Q} = ( \begin{matrix}{q}_{1} \\ ⋮ \\ {q}_{k}\end{matrix} )$$

is the vector of k quaternions representing the absolute orientations of the k sensors of the working sub-set, qᵢ is the quaternion representing the absolute orientation of the reference sensor Ci of the working sub-set and v̅ᵢ is the conjugate of the component of the eigenvector V corresponding to the reference sensor Ci.

The method described previously has been tested on networks of ten sensors comprising four reference sensors, to determine the position of sensors, by varying the error on positions of the reference sensors and the distances determined at the start between sensors. The infinite norm (greatest distance between the theoretical values and the determined values) has been used to evaluate the error on the determined positions. The results have shown that this method is robust.

It will be noted that the invention is not limited to the embodiment described previously. Indeed, it will be apparent to those skilled in the art that various modifications may be made to the embodiments described above, in the light of the teaching that has been disclosed to them.

In particular, the control installation could be used in fields other than the control of civil engineering structures, for example to monitor the movement of objects (vehicles, goods, persons, animals, etc.) to which the sensors could be fixed.

Moreover, the absolute layout parameters of objects could be determined after the successive executions of the loop of steps, instead of being determined little by little at each iteration of said loop of steps. For example, the invention could be advantageously applied to the method described in the conference cited at the beginning of the present description to improve it. Reliabilities could be associated with the distances and the determination of complete overlapping sub-sets could take account of these reliabilities. Moreover, the new distances determined at each iteration would find themselves associated with new reliabilities as provided by the invention. Thanks to the invention, it should thus be possible to do without the constraint according to which the distance between each pair of sensors separated by a distance less than a predetermined parameter R (called radio parameter) is known.

Moreover, it could be possible to select an incomplete working sub-set. In this case, step 220 for determining absolute layout parameters of objects of the working sub-set should simply be adapted.

Moreover, it is possible not to use at the start reference objects, in other words it is possible not to have step 208. In this case, the absolute layout parameters would be determined in relation to a frame attached to the set of objects, for example one of the objects chosen arbitrarily as reference. This variant may be interesting when one is interested in the positions of objects in relation to each other, and not compared to a fixed reference.

In the claims that follow, the terms used must not be interpreted as limiting the claims to the embodiments disclosed in the present description, but should be interpreted as including therein all the equivalents that the claims aim to cover on account of their formulation and the provision of which is within the reach of those skilled in the art by applying their general knowledge to the implementation of the teaching that has been disclosed to them.

1. Method for determining absolute layout parameters of objects on the basis of relative layout parameters provided by sensors, implemented by a processing device (106), characterised in that it comprises the following steps:
the obtaining (210; 210*) of relative layout parameters, each between two objects of a set of objects, wherein the relative layout parameters have been determined and transmitted to the processing device (106) by said sensors,
the association (211; 211*), with each relative layout parameter received, of a value, called reliability of the relative layout parameter,
the following loop of steps (212; 212*), executed at least once:
the selection (214; 214*) of a sub-set of objects, called working sub-set, as a function of the reliabilities of the relative layout parameters of the objects of the set,
the determination (230; 230*) of new relative layout parameters, each between an object belonging to the working sub-set and an object external to the working sub-set,
the association (232; 232*), with each new determined relative layout parameter, of a reliability calculated from the reliabilities of the relative layout parameters of the objects of the working sub-set,
and the following step:
the supply (231) of absolute layout parameters, each of an object of the set, said parameters being obtained from the new determined relative layout parameters.

2. Method according to claim 1, wherein the selection (214) of the working sub-set comprises:
the determination (216; 216*) of several sub-sets, called possible working sub-sets, and the calculation, for each possible working sub-set, of a value, called reliability of said possible working sub-set, from the reliabilities of the relative layout parameters of the objects of said possible working sub-set, and
the selection (218; 218*), as working sub-set, of the possible working sub-set having the greatest reliability.

3. Method according to claim 1 or 2, wherein the loop of steps (212; 212*) moreover comprises the determination (220; 220*) of the absolute layout parameter of each object of the working sub-set.

4. Method according to any of claims 1 to 3, wherein the selection of the working sub-set is moreover carried out by imposing that all of the relative layout parameters of the objects of the working sub-set are known.

5. Method according to claims 3 and 4, wherein, the objects for which the absolute layout parameter is known being called reference objects, the determination (220; 220*) of the absolute layout parameter of each object of the working sub-set is carried out from absolute layout parameters of the reference objects of the working sub-set and from the relative layout parameters of the objects of the working sub-set.

6. Method according to any of claims 1 to 5, wherein, the objects for which the absolute layout parameter is known being called reference objects, the objects of the working sub-set and the objects external to the working sub-set between which new relative layout parameters are determined, are reference objects.

7. Method according to any of claims 1 to 6, wherein the reliability associated with a new relative layout parameter between an object of the working sub-set and an object external to the working sub-set is determined according to a predetermined rule imposing that it is strictly less than the average of the reliabilities of the relative layout parameters of the objects of the working sub-set.

8. Method according to any of claims 1 to 7, wherein the relative layout parameter between two objects is the distance between said two objects, and wherein the absolute layout parameter of an object is the position of said object compared to a reference.

9. Method according to any of claims 1 to 7, wherein the relative layout parameter between two objects is the relative orientation between said two objects, and wherein the absolute layout parameter of an object is the absolute orientation of said object compared to a reference.

10. Method according to claims 4 and 9, wherein the loop of steps (212*) moreover comprises:
the determination (242) of an eigenvector of a matrix grouping together the relative orientations of the objects of the working sub-set, all of the components of the eigenvector being unitary,
the determination (244) of the absolute orientation of each object of the working sub-set, from the eigenvector and the absolute orientation of a reference object of the working sub-set.

11. Computer programme downloadable from a communications network and/or recorded on a support readable by computer and/or executable by a processor, characterised in that it comprises instructions for the execution of steps of a method (206; 240) for determining absolute layout parameters of objects according to any of claims 1 to 10, when said programme is executed on a computer.

12. Control installation (102), comprising:
a set of sensors (C1, C2, C3, C4, C5, C6), each sensor being designed to determine a relative layout parameter in relation to at least one other sensor of the set, and to transmit said parameter,
a processing device (106) designed to receive the parameters transmitted by the sensors and to implement a method (206; 240) for determining absolute layout parameters of the sensors according to any of claims 1 to 10.
